(19) United States
(12) Patent Application Publication
(10) Pub. No.: US 2012/0039329 A1
(43) Pub. Date: Feb. 16, 2012

(54) SYSTEM AND METHOD FOR USING PARTIALLY RECEIVED PACKETS IN COEXISTING NETWORKS

(75) Inventors: Yanjun SUN, Richardson, TX (US); Ariton E. XHAFA, Plano, TX (US); Xiaolin LU, Plano, TX (US); Josef PEERY, Kadima (IL)

(73) Assignee: TEXAS INSTRUMENTS INCORPORATED, Dallas, TX (US)

(21) Appl. No.: 13/028,002

(22) Filed: Feb. 15, 2011

Related U.S. Application Data
(60) Provisional application No. 61/304,671, filed on Feb. 15, 2010.

(51) Int. Cl. H04J 3/02; H04B 1/10; H04B 15/00; H04W 92/00

(52) U.S. Cl. 370/345

(57) ABSTRACT

A system and method for using partially received packets in coexisting networks. In one embodiment, a wireless receiver includes an interference detector and a packet validator. The interference detector is configured to determine that time multiplexing of a coexisting wireless network interferes with reception of a packet by the wireless receiver. The packet validator is configured to identify a type of the packet and useable data values of the packet when a partial packet is received due to the time multiplexing. The packet validator is configured to identify the type and useable data values of the packet based on a packet signature stored in the wireless receiver.

### CROSS-REFERENCE TO RELATED APPLICATION

The present application claims priority to U.S. Provisional Patent Application No. 61/304,671, filed on Feb. 15, 2010 (Attorney Docket No. TI-68626) entitled “Improving WLAN Scan via Partially Received Packets in Coexisting Networks” which is hereby incorporated herein by reference in its entirety.

### BACKGROUND

As wireless technologies proliferate, mobile wireless devices incorporate systems based on a multiplicity of different wireless standards. For example, a cellular telephone can accommodate a cellular network (e.g., Universal Mobile Telecommunications System), a wireless local area network (“WLAN”), such as network based on the IEEE 802.11 standard, and a wireless personal area network (“WPAN”) (e.g., a BLUETOOTH network).

Some of the various wireless standards adopted for use in mobile devices use adjacent and/or overlapping portions of the wireless spectrum. For example, both BLUETOOTH networks and IEEE 802.11b/g/n networks use the 2.45 gigahertz band.

### SUMMARY

A system and method for using partially received packets in coexisting networks. In one embodiment, a wireless receiver includes an interference detector and a packet validator. The interference detector is configured to determine that time multiplexing of a coexisting wireless network interferes with reception of a packet by the wireless receiver. The packet validator is configured to identify a type of the packet and useable data values of the packet when a partial packet is received due to the time multiplexing. The packet validator is configured to identify the type and useable data values of the packet based on a packet signature stored in the wireless receiver.

In another embodiment, a method includes identifying, by a wireless device, a packet, received via a wireless network, whose reception is interfered with by time multiplexing of a coexisting wireless network. The interference results in reception of a partial packet. The wireless device compares the partial packet to a stored packet signature. A packet type and useable data values of the partial packet are identified by the wireless device based on the comparing.

In a further embodiment, a wireless transmitter includes a monitoring system, a performance analyzer, and a transmission controller. The monitoring system is configured to determine whether a transmission by the transmitter on a wireless network will be interfered with by time multiplexing of a coexisting wireless network. The performance analyzer is configured to determine whether transmission of partial packets on the wireless network is beneficial to performance of the wireless network. The transmission controller is configured to transmit a packet that the monitoring system determines will be interfered with based on the performance analyzer determining that transmissions of partial packets are beneficial to performance of the wireless network.

In yet another embodiment, a system includes a first wireless device and a second wireless device. The first wireless device is configured to communicate via a first wireless network. The second wireless device is configured to communicate with the first wireless device via the first wireless network, and configured to communicate with a third wireless device via a second wireless network. The second wireless device includes a partial packet recognition system. The partial packet recognition system is configured to validate a partial packet received from the first wireless device, and to identify fields of the portion of the packet containing useable information. Time multiplexing of the first and second networks inhibits reception of a full packet comprising the partial packet.

### BRIEF DESCRIPTION OF THE DRAWINGS

For a detailed description of exemplary embodiments of the invention, reference will now be made to the accompanying drawings in which:

FIG. 1 shows a wireless system including wireless devices configured for operation on coexisting wireless networks in accordance with various embodiments;

FIG. 2 shows a diagram of activity relative to a wireless device configured for operation on coexisting wireless networks in accordance with various embodiments;

FIG. 3 shows a block diagram of a wireless device configured for operation on coexisting wireless networks in accordance with various embodiments;

FIG. 4 shows a flow diagram for a method for retrieving information from a partially received packet in accordance with various embodiments; and

FIG. 5 shows a flow diagram for a method for transmitting partial packets to improve network performance in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “partial packet” refers to a truncated, incomplete or fractional packet relative to a transmitted packet or a packet to be transmitted. For example, if an packet containing N symbols is transmitted, but N-M symbols are received because time multiplexing of coexisting networks causes the M symbols to not be received, then the N-M symbols constitutes a partial packet.

### DETAILED DESCRIPTION

The following discussion is directed to various embodiments of the invention.

Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Next generation mobile devices implement a plurality of wireless technologies to access different networks such as WiMAX® networks, wireless local area networks (“WLAN”) (e.g., IEEE 802.11 b/g/n networks), LTE® networks, wireless universal serial bus, or BLUETOOTH networks, etc. Such devices are referred to herein as “combo” devices. While increased access to these technologies benefits users and operators alike, interference among different technologies, particularly onboard a single combo device, introduces difficulties during concurrent operation of these technologies. For example, WLAN (in 2.4-2.5 gigahertz (GHz)) and WiMAX (in 2.3-2.4 GHz and 2.5-2.7 GHz) technologies operate in relatively close frequency bands with respect to each other—so close, that the out-of-band emission by either technology may saturate the receiver of the other technology resulting in potential blocking. Thus, the interference between different technologies operating in the same combo device creates coexistence problems.

Coexistence problems in a wireless device may be addressed by time multiplexing access to the medium by the various transceivers of the device, where each transceiver is associated with a different network. Unfortunately, time multiplexing can result in dropped packets when a combo device must swap transceivers during packet reception or transmission. Dropping packets due to time multiplexing reduces performance of the associated wireless network.

Embodiments of the present disclosure provide improved performance in systems using coexisting wireless networks by allowing a combo device to use data extracted from partially received packets. Embodiments further improve network performance by allowing transmission of packets that will be only partially received when it is determined that transmission of partial packets provides improved network performance.

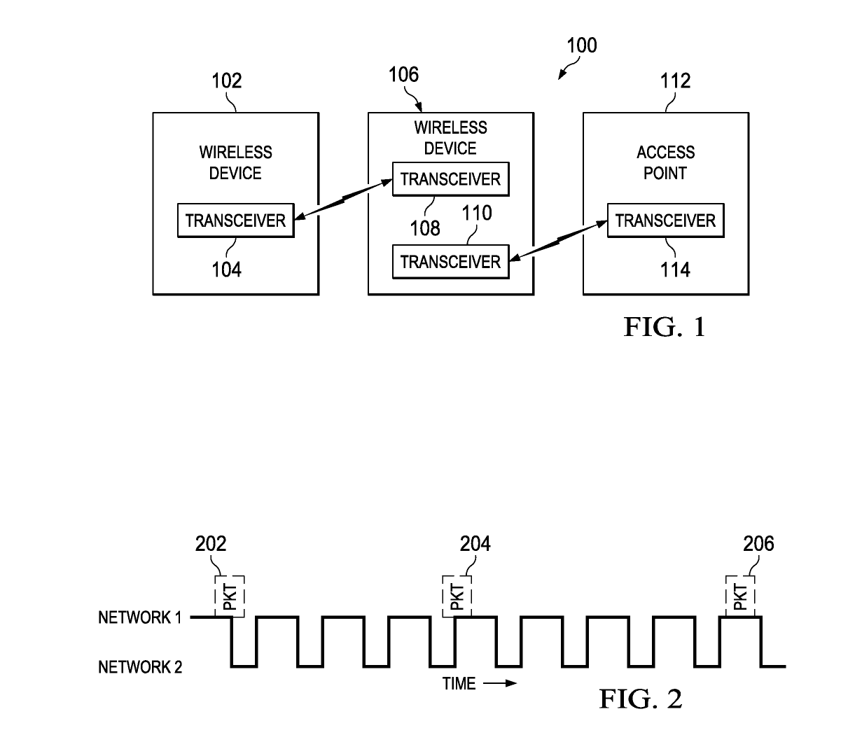

FIG. 1 shows a wireless system 100 including a wireless device 106 configured for operation on coexisting wireless networks in accordance with various embodiments. The wireless system 100 also includes an access point 112 and a wireless device 102. The access point 112 includes a wireless transceiver 114 that is configured to communicate with the wireless device 106 via a first wireless network. Similarly, the wireless device 106 includes a first transceiver 110 that is configured to provide communication via the first wireless network. In some embodiments of the system 100, the access point 112 and the wireless device 106 are configured to communicate with one another in accordance with a WLAN protocol (e.g., IEEE 802.11 b/g/n). In some embodiments, the transceivers 110, 114 are configured for communication according to another wireless standard (e.g., WiMAX).

The wireless device 106 also includes a second transceiver 108 configured for communication via a second wireless network using a protocol different from that of the first wireless network. The wireless device 102 includes a transceiver 104 configured to communicate with the wireless device 106 via the second wireless network. The first and second transceivers 110, 108 of the wireless device 106 may interfere with one another if operated concurrently on adjacent or overlapping bands.

In the wireless device 106, operation of the transceivers 110, 108 may be time multiplexed to mitigate inter-network interference. If at a given time, the second transceiver 108 is transmitting voice signals (e.g., over a BLUETOOTH network), and the transceiver 110 has yet to establish a connection with the access point 112, the transceiver 110 will be scanning the WLAN for access points. The transceiver 110 needs to receive a beacon packet transmitted by the access point 112 to determine the existence and capabilities of the access point 112. Unfortunately, time multiplexing medium access by the transceivers 110, 108 may cause packets transmitted on the WLAN to be only partially received before the medium is allocated to BLUETOOTH. Consequently, an extended time period may be required to receive a complete packet (e.g., receive a complete beacon packet and establish a connection with the access point 112).

FIG. 2 shows a diagram of activity relative to the wireless device 106 configured for operation on coexisting wireless networks in accordance with various embodiments. The time multiplexing of the transceivers 110, 108 is shown where the first transceiver 110 operates on NETWORK 1 (e.g., the WLAN) and the second transceiver 108 operates on NETWORK 2 (e.g., BLUETOOTH). Thus, the two transceivers 110, 108 use time multiplexing to share the medium. The transceivers 110, 108 alternate in time to transmit/receive information.

In FIG. 2, transmission of a first packet 202 is initiated by the access point 112 at a point in time when the first transceiver 110 is active, but before first packet is fully received, the first transceiver 110 is disabled and the second transceiver 108 is enabled. Transmission of a second packet 204 is initiated by the access point 112 at a point in time when the second transceiver 108 is active, and transmission completes after the second transceiver 108 is disabled and the first transceiver 110 is enabled. Transmission of a third packet 206 is initiated by the access point 112 at a point in time when the first transceiver 110 is active, and transmission completes before the first transceiver 110 is disabled.

The first and second packets 202, 204 are only partially received by the wireless device 106 because the network 1 transceiver 110 is not enabled for the entire transmission time of the packets. Consequently, a combo device not configured to use partial packets may drop the first and second packets 202, 204 due to failure of a packet integrity check (e.g. a cyclic redundancy check) and receive only the third packet 206. If the packets 202-206 are beacon packets, such a combo device will incur substantial delay in connecting to the WLAN while awaiting the third packet 206.

Embodiments of the present disclosure validate partially received packets and extract information therefrom. In FIG. 2, if the packets 202-206 are beacon packets, then the information for connecting to the WLAN that is extracted only from the third packet 206 in some combo devices may be obtained from partially received first or second packets 202, 204 by the wireless device 106. Thus, embodiments disclosed herein use information from a partially received packet to improve network performance if the partiality of the packet is due to interference caused by network coexistence.

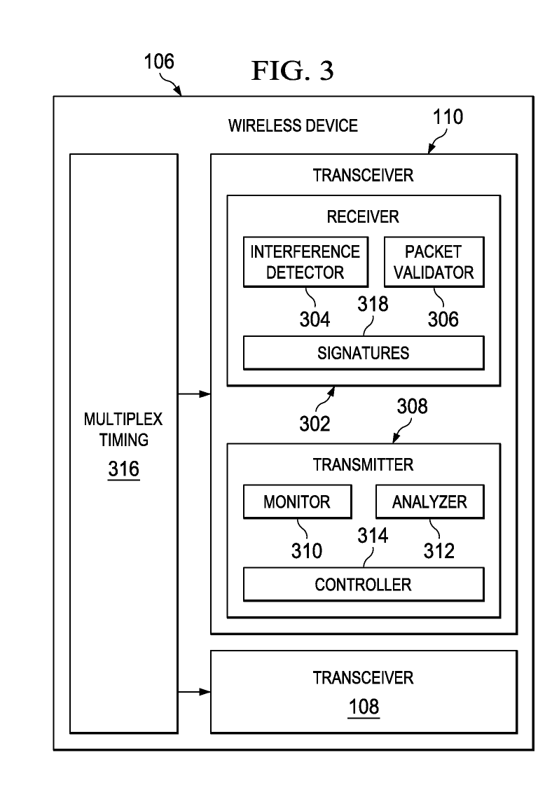

FIG. 3 shows a block diagram of the wireless device 106 configured to use partially received packets caused by for operation of coexisting wireless networks in accordance with various embodiments. As described above, the wireless device 106 includes transceivers 108 and 110. The transceiver 110 is configured to communication via a first wireless network, and the transceiver 108 is configured to communicate via a second wireless network. A multiplex timing controller 316 controls timing of access to the medium by each transceiver 110, 108.

The transceiver 110 includes a receiver 302 and a transmitter 308. The receiver 302 is configured to recognize and validate partially received packets and to extract information from partial packets that would otherwise be wasted if the packets were dropped. The receiver 302 includes an interference detector 304, a packet validator 306, signature information storage 318, and various other components, such as decoders, amplifiers, and filters (not shown). The interference detector 304 determines whether reception of a packet will be or has been interfered with by time multiplexing of the transceivers 110, 108. For example, based on expected multiplex timing, the interference detector 304 can predict whether a packet currently being received will be interrupted by the alternation of transceiver medium access. Information regarding multiplex timing can be provided by the multiplex timing controller 316.

The packet validator 306 is configured to verify a partially received packet identified by the interference detector 304, to determine the identity the packet (i.e., the type of the packet, e.g., a beacon packet), and to identify useable data fields of the packet and extract useable information therefrom. The packet as a whole may be corrupt due to coexistence interference. However, the packet validator can ascertain the identity of the partially received packet based on packet signature information stored in signature storage 318. Any number of packet signatures may be stored in signature storage 318 and applied/compared to a partially received packet to identify the packet. For example, signatures for beacon packets, control packets, management information packets, etc. may be stored in the signature storage 318 and applied to partially received packets.

Packet signatures can include information regarding the structure and content of various types of packets. Some packet signatures may require known values in specified fields of the packet to verify packet type. Some packet types may include a header located at a known offset from the start of the packet, with the header including a check value, such as a cyclic redundancy check or parity value. Based on a stored packet signature, the packet validator can apply a check algorithm (e.g., a CRC algorithm) as required by a specific packet type to verify a header or other portion of the packet. Such verification provides one indication of packet identity. Failure of an applied check algorithm indicates that the partial packet does correspond to the applied signature.

A stored packet signature may require that field of a partial packet contain a predetermined value. If a field of a partial packet contains a value different from that required by a stored signature, then the packet may be discarded. For example, the physical layer convergence protocol (PLOP) header includes a rate field. If a signature for a beacon packet requires a value in the rate field indicating 1 megabits per second (Mbps) for IEEE 802.11b/g/n in the 2.4 GHz band or 6 Mbps for IEEE 802.11a/n in the 5 GHz band, and the rate field of partially received packet does not include the appropriate value, the packet validator 306 may cause the partial packet to be discarded, or tested against additional signatures.

The packet validator 306 may also check a Frame Control field of a partially received packet to verify packet identity. The packet validator 306 inspects the Frame Control field to determine whether the packet is of a known or expected type, such as a beacon packet or a control/management packet.

If the packet validator 306 identifies the packet type of a partial packet based on the signatures, the packet validator 306 decodes information from fields of the packet. For example, if the partial packet is identified as a beacon, then information such as timestamp, beacon interval, and service set identification (SSID) can be extracted from the packet and used to connect to the access point 112. The SSID and basic SSID (BSSID) of an access point are disclosed in the first fifty bytes of a beacon packet. Different information may be extracted from other partial packet types. If any value extracted from the partial packet is not accord with an expected value of the field, the packet validator 306 may cause the packet to be discarded or check the packet against additional signatures.

Some embodiments of the packet validator 306 monitor communications on the wireless network that are not directed to the wireless device 106 and gather and store information extracted from captured packets that may be used to validate partially received packets. For example, the packet validator 306 may capture a packet traveling between the access point 112 and another wireless device and extract the SSID or the BSSID of the access point 112 from the packet. If a partial beacon packet is later received, the packet validator 306 can compare the captured SSID or BSID to that contained in the partial packet, thereby increasing confidence that the information retrieved from the partial packet is valid.

Some embodiments of the receiver 302 are configured to expedite reception of a complete packet. If the packet validator 306 identifies a received partial packet as a packet type for which the transmission time of a subsequent packet of the same type can be predicted (e.g., a periodically transmitted packet), the packet validator 306 can influence transmission of the subsequent packet such that the subsequent packet is transmitted at a time that ensures reception of the complete packet. Such operation is advantageous if the packet validator 306 is unable to extract sufficient information from the received partial packet.

The packet validator 306 can initiate transmission of CTS2Self frames to control the timing of the next transmission of the periodic packet. The CTS2Self frames may start plus or minus a delta interval, within which the periodic packet is expected to be transmitted. The CTS2Self frames should cover the remaining duration of any idle gap associated with use of the second network by the second transceiver 108, as well as the time interval in which the second transmitter 108 is enabled. The CTS2Self frames will force the periodic packet to be transmitted at a time when full reception is possible by the receiver 302. Thus, the time duration set by the CTS2Self frames should take into account the duration of the periodic packet (e.g., knowing the data rate at which the packet will be transmitted and the approximate packet size, the duration can be easily calculated). Alternatively, if the activities on the second transceiver 108 have lower priority than receiving the periodic packet on the first transceiver 110 or can be rescheduled to a time window that does not overlap with reception of the periodic packet, then the packet validator 306 can influence the multiplex timing controller 316 to adjust the multiplex time such that the subsequently transmitted periodic packet is received without sending a CTS2Self frame.

The transceiver 110 also includes the transmitter 308 as shown in FIG. 3. Time multiplexing can result in packets being only partially transmitted prior to the medium being allocated to the transceiver 108. The transmitter 308 is configured to transmit packets that will be only partially received. Partial packet transmission may be based on analysis indicating that transmission of such packets is beneficial to performance of the wireless network.

The transmitter 308 includes a monitoring system 310, a performance analyzer 312, a transmission controller 314, and various other components, such as an encoder, amplifiers, and filters (not shown). The monitoring system 310 determines whether a scheduled transmission by the transmitter 308 will be interfered with by time multiplexing of coexisting networks (i.e., allocation of the medium to the transceiver 108). The timing of medium reallocation can be determined based on information provided by the multiplex timing controller 316.

The performance analyzer 312 determines whether transmission of a scheduled packet that will be only partially transmitted, and therefore only partially received, will be beneficial to network performance. Some embodiments analyze the performance of the wireless network while transmitting partial packets versus the performance of the network while not transmitting partially received packets to make such a determination.

The transmission controller 314 transmits the scheduled packet that will be only partially transmitted in response to the performance analyzer 312 determining that partial packets are beneficial to network performance.

Various components of the transceiver 110, including at least some portions of the interference detector 304, the packet validator 306, the performance analyzer 312, the monitoring system 310 and the transmission controller 314 can be implemented using a processor and software programming that causes the processor to perform the operations described herein. In particular, a processor executing software programming can detect interference with packet reception or transmission caused by time multiplexing coexisting networks, and to validate and identify the type and useable data values of a partially received packet. Suitable processors include, for example, general-purpose processors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, or combinations thereof.

Some embodiments can implement portions of the transceiver 110 using dedicated circuitry (e.g., dedicated circuitry implemented in an integrated circuit). Some embodiments may use a combination of dedicated circuitry and a processor executing suitable software. Selection of a hardware or processor/software implementation of embodiments is a design choice based on a variety of factors, such as cost, time to implement, and the ability to incorporate changed or additional functionality in the future.

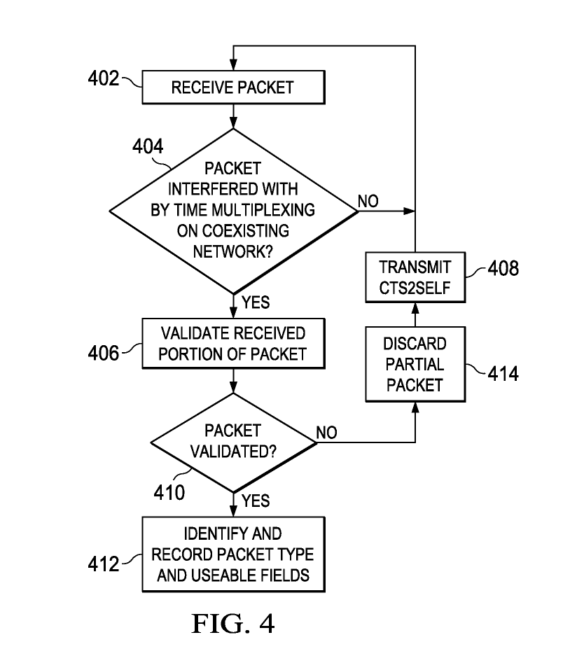

FIG. 4 shows a flow diagram for a method for retrieving information from a partially received packet in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 4, as well as other operations described herein, can be implemented as instructions stored in a computer readable medium and executed by a processor.

In block 402, the wireless device 106 is time multiplexing access to coexisting wireless networks by alternating medium access between the transceivers 110, 108. Each of the transceivers 110, 108 is configured for use with a different one of the coexisting wireless networks. The transceiver 110 is receiving a packet transmitted by a different wireless device (e.g., the access point 112) via the first of the coexisting wireless networks.

In block 404, the transceiver 110 determines whether the reception of the packet being received will be interfered with by the time multiplexing of transceivers 110, 108. That is, whether medium access will be granted to the transceiver 108 and withdrawn from the transceiver 110 before the packet is completely received by the transceiver 110. If time multiplexing interferes with reception of the packet, then the packet will be only partially received by the transceiver 110.

In some embodiments, the transceiver 110 determines that time multiplexing has interfered with packet reception when or after media access is transferred from the transceiver 110 to the transceiver 108 during reception of the packet.

If packet reception is not interfered with by time multiplexing, then reception of subsequent packets continues in block 402.

If packet reception is interfered with by time multiplexing, then in block 406, the transceiver validates the received portion of the packet. The transceiver 110 validates and identifies the type of the partial packet by comparing stored packet signature information to the partially received packet. A given signature may indicate that a particular packet type contains defined values in specific fields and/or that a portion of the partial packet may be verified using a check character included in capable of verifying a portion of the partial packet. In some embodiments, header verification using a header check value, and/or verification of known packet field values (e.g., PLCP rate field value, frame control field value, etc.) is used to identify the packet type and validate data values.

In some embodiments, information related to wireless devices using the same wireless network as the transceiver 110, and the packets transmitted thereby, is derived from packets transmitted between the devices and received by the transceiver 110. Such information is added to the signatures and compared to values extracted from corresponding fields of the partially received packet to verify packet identity.

In block 410, if the partial packet has been validated based on the stored signatures, then in block 412, information extracted from the fields of the partial packet, for example, the packet identity and useable information are recorded and applied. For example, if the partially received packet is validated against a beacon packet signature, then the transceiver 110 may apply information (e.g., SSID) extracted from the packet to connect to the access point 112 that transmitted the beacon packet. Similarly, if the partially received packet is validated against a control packet signature, then the transceiver 110 may apply information extracted from the partial packet to modify transceiver 110 operation relative to the wireless network.

If, in block 410, the partially received packet is not validated against a stored signature, then in block 414 partially received packet is discarded.

In block 408, some embodiments expedite reception of a full packet when a partially received packet has been identified, and the transceiver 110 is unable to extract sufficient data from fields of the partial packet to make use of the packet. If the transceiver 110 identifies the partial packet as being transmitted at a known interval, then the transceiver 110 can transmit CTS2Self frames to inhibit transmission of a subsequent instance of the packet until a time when the packet can be fully received by the transceiver 110. Alternatively, if the activities on the second transceiver 108 have lower priority than receiving the periodic packet on the first transceiver 110 or can be rescheduled to a time window that does not overlap with reception of the periodic packet, then the packet validator 306 can influence the multiplex timing controller 316 to adjust the multiplex time such that the subsequently transmitted periodic packet is received without sending a CTS2Self frame.

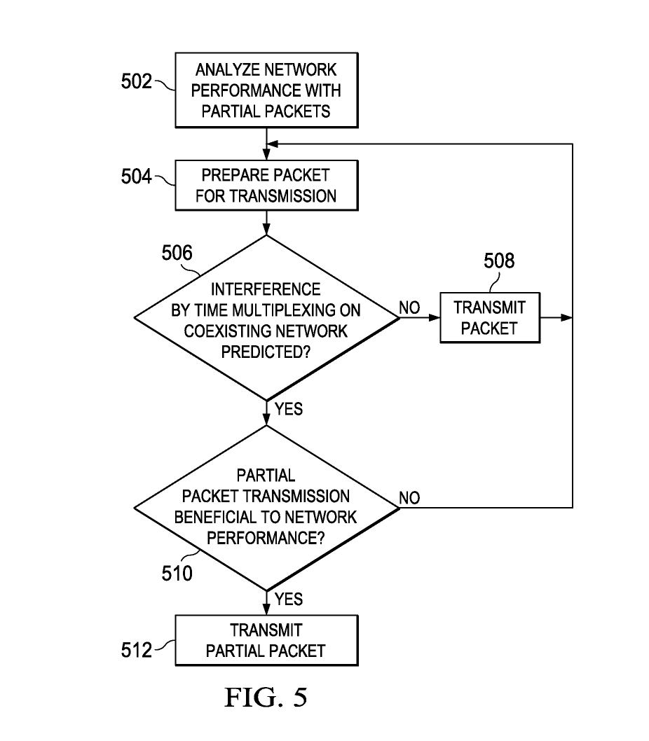

FIG. 5 shows a flow diagram for a method for transmitting partial packets to improve network performance in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 5, as well as other operations described herein, can be implemented as instructions stored in a computer readable medium and executed by a processor.

In block 502, the wireless device 106 is time multiplexing access to coexisting wireless networks by alternating medium access between the transceivers 110, 108. Each of the transceivers 110, 108 is configured for use with a different one of the coexisting wireless networks. The transceiver 110 analyzes the performance of the wireless network relative to the transmission of packets on the network whose transmission is interfered with by time multiplexing. Some embodiments gather network performance data while partial packet transmission is enabled and corresponding data while partial packet transmission is disabled and based on comparisons of the gathered data determine whether transmission of partial packets is beneficial to network performance.

In block 504, the transceiver 110 prepares a packet for transmission.

In block 506, the transceiver 110 determines whether time multiplexing will interfere with transmission of the packet. The determination may be based multiplex timing information provided by the multiplex timing controller 316.

If the transceiver 110 determines that transmission of the packet will not be interfered with by time multiplexing of the coexisting networks, then in block 508, the transceiver 110 transmits the packet.

If the transceiver 110 determines that transmission of the packet will be interfered with by time multiplexing of the coexisting networks, then in block 510, the transceiver 110 determines whether transmission of the partial packet will be beneficial to network performance. The determination may be based on the previously conducted analysis of network performance with partial packets. The determination may also be based on an analysis of the information that will be contained in the partial packet and the usefulness of the information to a wireless device that receives the partial packet. For example, if the portion of the packet transmitted prior to transfer of the medium to the transceiver 108 contains useable information that can be identified and validated by a receiving device, then the transmission of the partial packet may be beneficial to network performance.

If transmission of the partial packet is determined not to be beneficial to network performance, then the packet is not transmitted, and may be scheduled from transmission at a different time (e.g., a time when transmission will not be interrupted).

If transmission of the partial packet is determined to be beneficial to network performance, then the partial packet is transmitted in block 512.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless receiver, comprising:
an interference detector configured to determine that time multiplexing of a coexisting wireless network interferes with reception of a packet by the wireless receiver;
a packet validator configured to identify a type of the packet and useable data values of the packet when a partial packet is received due to the time multiplexing;
wherein the packet validator is configured to identify the type and useable data values of the partial packet based on a packet signature stored in the wireless receiver.

2. The wireless receiver of claim 1, wherein the packet validator is configured to perform verification of the partial packet based on a check value included in the packet and corresponding to a portion of the partial packet, wherein the verification indicates that the portion of the partial packet is incorrupt.

3. The wireless receiver of claim 2, wherein the packet validator is configured to verify a header of the partial packet based on the check value.

4. The wireless receiver of claim 1, wherein the packet validator is configured to compare a predetermined value to a value of a given field of the partial packet, and to discard the partial packet if the value of the given field is not equal to the predetermined value.

5. The wireless receiver of claim 4, wherein the given field is one of a transmission rate field and a frame control type field.

6. The wireless receiver of claim 1, wherein the packet validator is configured to identify a portion of the packet that is received while the coexisting wireless network is not interfering with reception of the packet.

7. The system of claim 1, wherein the partial packet is a portion of a beacon packet transmitted by an access point and the packet validator is configured to identify a basic service set identifier of the access point based on the partial packet.

8. The system of claim 1, wherein the packet validator is configured to initiate a clear-to-send transmission that inhibits transmission of a subsequent packet until a time when the time multiplexing allows the subsequent packet to received in full, the initiation being based on failure to identify sufficient useable data values in the partial packet.

9. A method, comprising:
identifying, by a wireless device, a packet, received via a wireless network, whose reception is interfered with by time multiplexing of a coexisting wireless network, the interference resulting in reception of a partial packet;
comparing, by the wireless device, the partial packet to a stored packet signature;
identifying, by the wireless device, based on the comparing, a packet type and useable data values of the partial packet.

10. The method of claim 9, wherein the identifying useable data values comprises:
verifying a portion of the partial packet based on a check value included in the partial packet, wherein the check value is associated with the portion, and identifying fields of the portion as containing useable data values.

11. The method of claim 9, wherein the identifying useable data values comprises:
identifying a portion of the packet received while the coexisting wireless network is not interfering with reception of the packet; and
verifying fields included in the portion.

12. The method of claim 9, wherein the identifying useable data values comprises:
comparing a predetermined value to a value contained in the partial packet; and
discarding the partial packet based on the value contained in the partial packet being unequal to the predetermined value.

13. The method of claim 12, further comprising extracting the predetermined value from a packet transmitted on the wireless network and not addressed to the wireless device.

14. The method of claim 9, further comprising identifying an access point that transmitted the packet based on the useable data values, wherein only the partial packet is received.

15. The method of claim 9, further comprising:
determining that an insufficient number of useable data values are identifiable in the partial packet; and
scheduling a clear-to-send transmission that inhibits a transmission of a subsequent packet until a time when the time multiplexing allows the subsequent packet to be received in full by the wireless device.

16. A wireless transmitter, comprising:
a monitoring system configured to determine whether a transmission by the transmitter on a wireless network will be interfered with by time multiplexing of a coexisting wireless network;
a performance analyzer configured to determine whether transmission of partial packets on the wireless network is beneficial to performance of the wireless network; and
a transmission controller configured to transmit a packet that the monitoring system determines will be interfered with based on the performance analyzer determining that transmissions of partial packets are beneficial to performance of the wireless network.

17. The wireless transmitter of claim 16, wherein the performance analyzer is configured to:
analyze performance of the wireless network while transmitting partial packets;
analyze performance of the wireless network while not transmitting partial packets; and
determine whether transmission of partial packets is beneficial to the performance of the wireless network based on a comparison of network performance while transmitting partial packets to network performance while not transmitting partial packets.

18. A system, comprising:
a first wireless device configured to communicate via a first wireless network; and
a second wireless device configured to communicate with the first wireless device via the first wireless network, and configured to communicate with a third wireless device via a second wireless network; the second wireless device, comprising:
a partial packet recognition system configured to:
validate a partial packet received from the first wireless device, wherein reception of the a packet comprising the partial packet is inhibited by time multiplexing of the first and second wireless networks; and
identify fields of the partial packet containing useable information.

19. The system of claim 18, wherein the partial packet recognition system is configured to determine an identity of the first wireless device based on the useable information.

20. The system of claim 18, wherein the partial packet consists of packet data received while the second wireless network is not interfering with reception of the packet.

21. The system of claim 18, wherein the partial packet recognition system is configured to validate the partial packet based on a check value included in the partial packet.

22. The system of claim 18, wherein the partial packet recognition system is configured to compare a predetermined value to a value contained in the partial packet, and to discard the partial packet if the value of the value contained in the partial packet is not equal to the predetermined value.

23. The system of claim 22, wherein the partial packet recognition system acquires the predetermined value based on a transmission between the first wireless device and a fourth wireless device that communicate via the first wireless network.

24. The system of claim 18, wherein the second wireless device comprises a transmitter and the partial packet recognition system is configured to direct the transmitter to transmit a clear-to-send signal that inhibits the first wireless device from transmitting on the first wireless network until the transmission can be received in full, the direction to transmit the clear-to-send being based on the partial packet recognition system being unable to identify a predetermined amount of useable information in the partial packet.

25. The system of claim 18, wherein the first wireless device comprises a transmitter configured to:
transmit on the first wireless network;
predict whether time multiplexing of the first and second networks will interfere with a next transmission on the first wireless network;
determine whether a portion of the transmission not interfered with by the time multiplexing is beneficial to performance of the first wireless network; and
initiate the next transmission based on the determination.

26. The system of claim 25, wherein the transmitter is configured to:
analyze network performance while transmitting partial packets; and
analyze network performance while not transmitting partial packets;
wherein the transmitter determines whether transmission of a partial packet is beneficial to the first wireless network based on a comparison of network performance while transmitting partial packets to network performance while not transmitting partial packets.

27. A method, comprising:
determining, by a wireless device, prior to initiation of transmission, whether transmission of a packet will be interrupted by time multiplexing of coexisting wireless networks;
determining, by the wireless device, whether reception of a partial packet resulting from transmission of the packet being interrupted by time multiplexing is beneficial to performance of a given wireless network on which the partial packet is transmitted; and
transmitting the partial packet based on the determining finding that the partial packet is beneficial to performance of the given wireless network.

28. The method of claim 27, wherein the determining whether reception of a partial packet is beneficial comprises:
analyzing performance of the given wireless network while transmitting partial packets;
analyzing performance of the given wireless network while not transmitting partial packets; and
determining whether transmission of partial packets is beneficial to the performance of the given wireless network based on a comparison of network performance while transmitting partial packets to network performance while not transmitting partial packets.

29. The method of claim 27, wherein the determining whether reception of a partial packet is beneficial comprises determining whether a portion of the packet that will transmitted prior to the transmission being interrupted contains data values that are useable by a receiving wireless device without a portion of the packet that will not be transmitted due to the time multiplexing.
